(19) United States
(12) Patent Application Publication
(10) Pub. No.: US 2020/0164397 A1
(43) Pub. Date: May 28, 2020

(54) SPRINKLER HEAD EXTENSION

(71) Applicant: Alan Shoemake, Cedar Park, TX (US)

(72) Inventor: Alan Shoemake, Cedar Park, TX (US)

(21) Appl. No.: 16/682,543

(22) Filed: Nov. 13, 2019

Related U.S. Application Data
(60) Provisional application No. 62/771,888, filed on Nov. 27, 2018.

(51) Int. Cl. B05B 15/72

(52) U.S. Cl. CPC B05B 15/72

(57) ABSTRACT

Apparatus and associated methods relating to sprinkler head extension include a shaft extender that connects with an original shaft and a cap extender that replaces an original cap of a sprinkler head. In an illustrative example, a sprinkler head extension includes a shaft extender. The shaft extender has a coupling arrangement that connects the shaft extender with an original shaft in the sprinkler head. The sprinkler head extension also includes a cap extender that is configured to replace an original cap of the sprinkler head extension and provide a corresponding size to contain the shaft extender. By using the shaft extender and cap extender, a desired extended height of the sprinkler head may be obtained without replacing the whole sprinkler head. The sprinkler head extension may allow a user to raise the sprinkler head and avoid digging up and ruining the grass around the sprinkler head that needs to be raised.

### CROSS-REFERENCE TO RELATED APPLICATIONS

This application also claims the benefit of U.S. Provisional Application Ser. No. 62/771,888, titled “SPRINKLER HEAD EXTENSION,” filed by Alan Shoemake, on Nov. 27, 2018.

This application incorporates the entire contents of the foregoing application(s) herein by reference.

### TECHNICAL FIELD

Various embodiments relate generally to sprinkler head extensions.

### BACKGROUND

Various climates may have different level of precipitation and humidity. In many residences and commercial properties, people have installed sprinkling systems to keep various plants sufficiently watered during levels of low precipitation. Some properties may use a “xeriscape” lawn that does not require significant watering. However, for lawns that have grass or other plants that require frequent watering, automated sprinklers may provide the necessary water for the lawn without continual monitoring by the owner of the associated property.

### SUMMARY

Apparatus and associated methods relating to sprinkler head extension include a shaft extender that connects with an original shaft and a cap extender that replaces an original cap of a sprinkler head. In an illustrative example, a sprinkler head extension includes a shaft extender. The shaft extender has a coupling arrangement that connects the shaft extender with an original shaft in the sprinkler head. The sprinkler head extension also includes a cap extender that is configured to replace an original cap of the sprinkler head extension and provide a corresponding size to contain the shaft extender. By using the shaft extender and cap extender, a desired extended height of the sprinkler head may be obtained without replacing the whole sprinkler head. The sprinkler head extension may allow a user to raise the sprinkler head and avoid digging up and ruining the grass around the sprinkler head that needs to be raised.

The details of various embodiments are set forth in the accompanying drawings and the description below. Other features and advantages will be apparent from the description and drawings, and from the claims.

### BRIEF DESCRIPTION OF THE DRAWINGS

FIG. 1 shows an exemplary sprinkler head extension included with an exploded view of an extended sprinkler head system.

FIG. 2 shows the exemplary sprinkler head extension assembled with the sprinkler head.

FIG. 3(A) depicts a side view of an exemplary shaft extender.

FIG. 3(B) depicts a side view of an exemplary cap extender.

FIG. 4(A) depicts a top perspective view of the exemplary shaft extender.

FIG. 4(B) depicts a bottom perspective view of the exemplary shaft extender.

FIG. 4(C) depicts a top perspective view of the exemplary cap extender.

FIG. 4(D) depicts a bottom perspective view of the exemplary cap extender.

FIG. 5 depicts a flow chart of an exemplary method to identify sprinkler heads to be extended.

FIG. 6 depicts a flow chart of a method to assemble an exemplary sprinkler head extension to a sprinkler head.

Like reference symbols in the various drawings indicate like elements.

### DETAILED DESCRIPTION OF ILLUSTRATIVE EMBODIMENTS

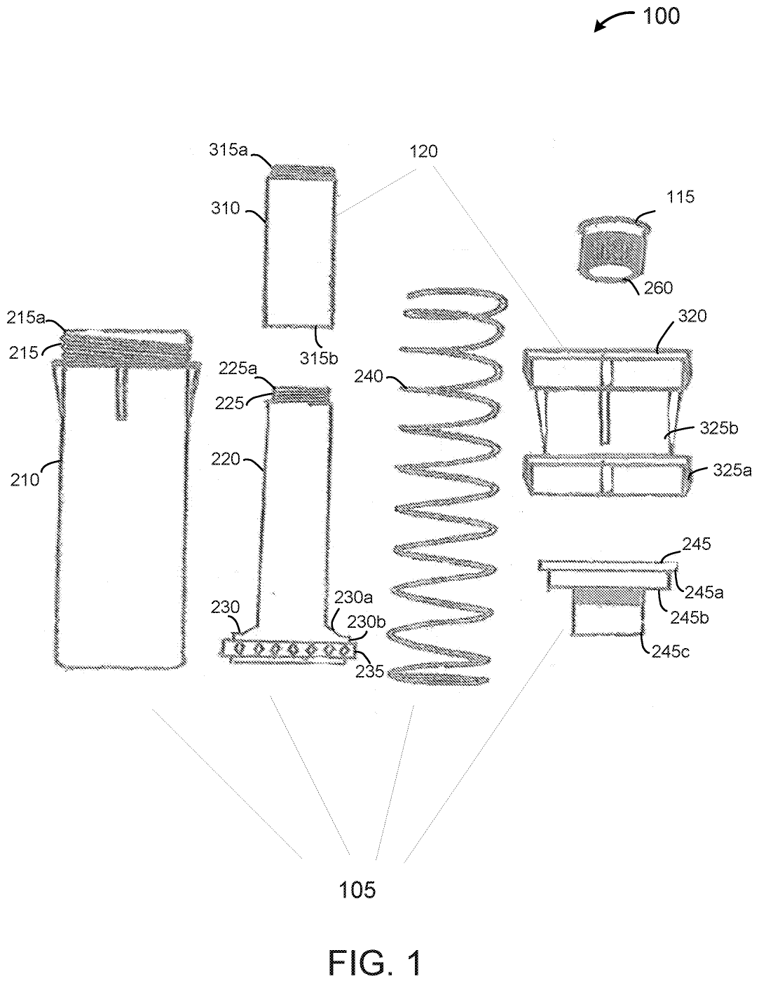

FIG. 1 shows an exemplary sprinkler head extension included with an exploded view of an extended sprinkler head system. An extended sprinkler head system 100 may be connected with an underground supply to be used for lawn irrigation. The sprinkler head system 100 includes a lower apparatus 105. The lower apparatus 105 may be connected with a water supply pipe through a T-shape coupling to provide a hollow water passageway. The sprinkler head system 100 also includes a nozzle 115. After a period of time, the ground may absorb water sprayed from the sprinkler head system 100 and induce the sprinkler head system 100 to sink. Because sprinkler heads be installed in newly dug and back filled trenches, the sprinkler head 100 may tend to sink over time. To keep the sprinkler head 100 effective, a head extension device 120 may be used to lift the nozzle 115. Accordingly, the extended sprinkler head system 100 includes the lower apparatus 105 and a head extension device 120 configured to attach with the lower apparatus 105. The nozzle 115 may be placed on the head extension device 120. In some embodiments, a new nozzle may be used to replace the nozzle 115 to perform a variety of functions.

The lower apparatus 105 includes a spray head 210. The spray head 210 has a top extension 215. The top extension 215 is configured with thread 215a. The lower apparatus 105 also includes a shaft 220. The shaft 220 includes a top shaft portion 225. The top shaft portion is configured with thread 225a to be connected with the nozzle 115. The shaft 220 also includes a bottom portion 230. The bottom portion 230 is a reversed-funnel-shape portion that configured to guide water flow direction and includes an inclined part 230a and a vertical part 230b. The lower apparatus 105 also includes a gear assembly 235 that attached with the vertical part 230b of the shaft 220. The gear assembly 235 advantageously helps the shaft 220 keep stable in a lateral direction when the shaft 220 is placed inside the spray head 210. The lower apparatus 105 also includes a spring 240. The spring 240 is configured to wrap around the shaft 220. The spring 240 is biased such that when the water pressure is removed, the spring 240 causes the shaft 220 to retract. The lower apparatus 105 also includes a seal device 245. The seal device 245 has a first recess portion 245a. The first recess portion 245a is configured to attach with an upper side wall of the top extension 215 of the spray head 210. The seal device 245 also includes a second recess portion 245b. The second recess portion 245b is configured to attach with the spring 240 to provide a pressure to the spring 240. The seal device 245 also includes a tube portion 245c. The tube portion 245c is designed to have a diameter that can make the shaft 220 passes through precisely to further guide the shaft 220.

The sprinkler head system 100 also includes the nozzle 115. The nozzle 115 is fabricated with a thread part 260. The thread part 260 is fabricated to have a corresponding profile relative to the thread 225a of the shaft 220 that can make the nozzle 115 connect with the shaft 220 precisely.

A head extension device 120 includes a shaft extender 310. The shaft extender 310 includes an upper thread portion 315a. The upper thread portion 315a is fabricated to have the same profile with a thread 225a of a shaft 220 that can make a nozzle 115 connect with the shaft 220 to provide a passage for water. The shaft extender 310 also includes a lower thread portion 315b. The lower thread portion is fabricated to have a corresponding profile relative to the thread 225a of the shaft 220 that can make the shaft extender 310 connect with the shaft 220 precisely to prevent water leakage. In some embodiments, one or more shaft extender 310 may be used to extend the shaft 220. By using the shaft extender 310, no more additional splines or set screws are needed.

The head extension device 120 also includes a cap extender 320. The cap extender 320 includes a bottom cap 325a. The bottom cap 325a has the same diameter with the cap 250. The bottom cap 325a includes thread 330 designed on the inner surface of the bottom cap 325a. The bottom cap 325a is designed to connect with the spray head 210 through thread 215a and thread 330. The cap extender 320 also includes a hollow body 325b. The hollow body 325b contains the shaft extender 310.

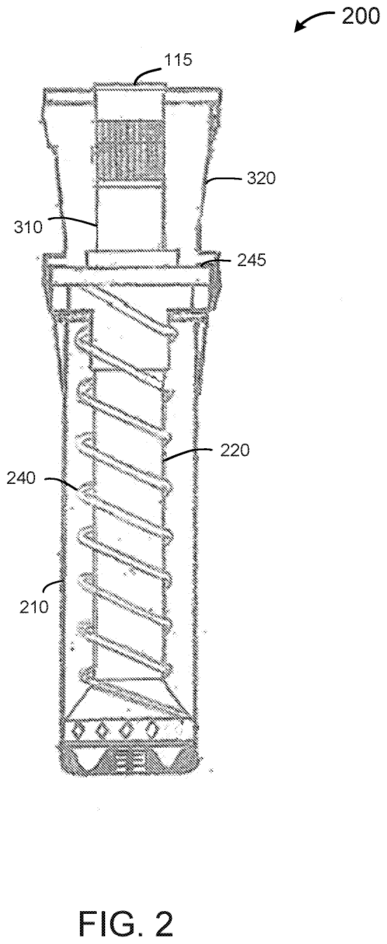

FIG. 2 shows the exemplary sprinkler head extension assembled with the sprinkler head. The assembled extended sprinkler head system 200 includes the head extension device (including shaft extender 310 and cap extender 320). The assembled sprinkler head system 200, utilizing the head extension device, makes the nozzle 115 have a higher relative height to a T-shape coupling (not shown), compared to when it is assembled without the aid of the head extension device. The assembled extended sprinkler head system 200 also includes the nozzle 115. The thread part 260 of the nozzle 115 is fabricated to have a corresponding profile relative to the thread 315a of the shaft extender 310 that can make the nozzle 115 connect with the shaft extender 310 precisely. By adding the shaft extender 310 and replacing the cap 250 into the cap extender 320, a sprinkler head with an extended height can be obtained without changing the whole sprinkler head.

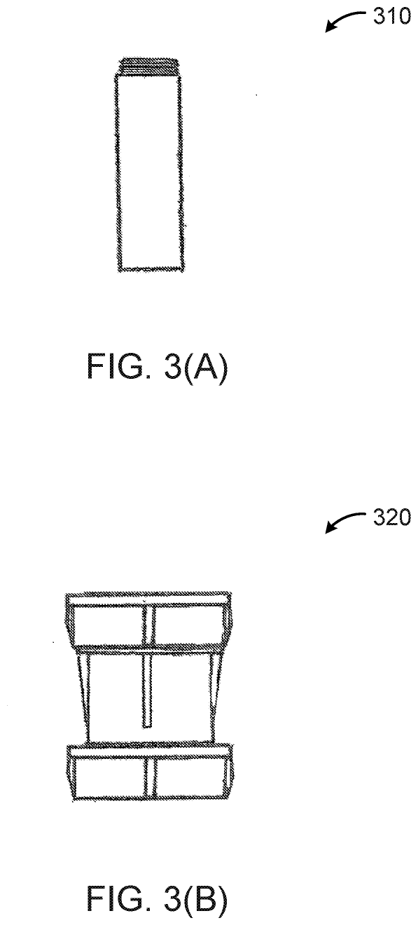

FIG. 3(A) depicts a side view of an exemplary shaft extender.

FIG. 3(B) depicts a side view of an exemplary cap extender.

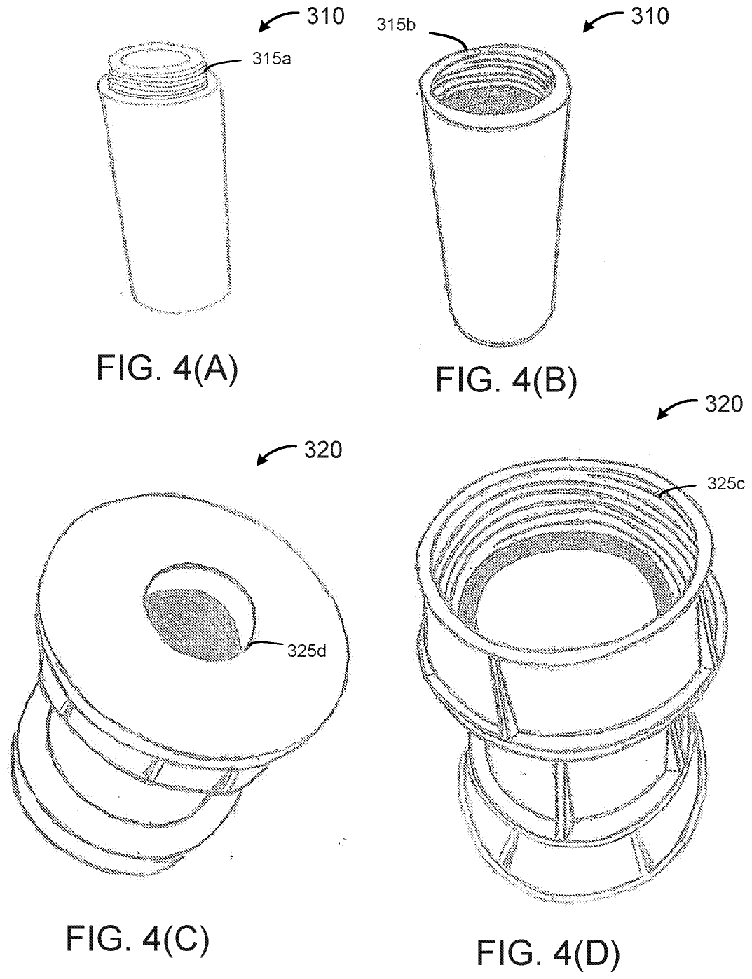

FIG. 4(A) depicts a top perspective view of the exemplary shaft extender.

FIG. 4(B) depicts a bottom perspective view of the exemplary shaft extender.

FIG. 4(C) depicts a top perspective view of the exemplary cap extender. The cap extender 320 includes an aperture 325d in which the top nozzle 115 may be located/fixed.

FIG. 4(D) depicts a bottom perspective view of the exemplary cap extender. The cap extender 320 includes lower cap threads 325c that couple to the upper body threads 215a, to mechanically and releasably couple the cap extender 320 to the hollow shaft 220.

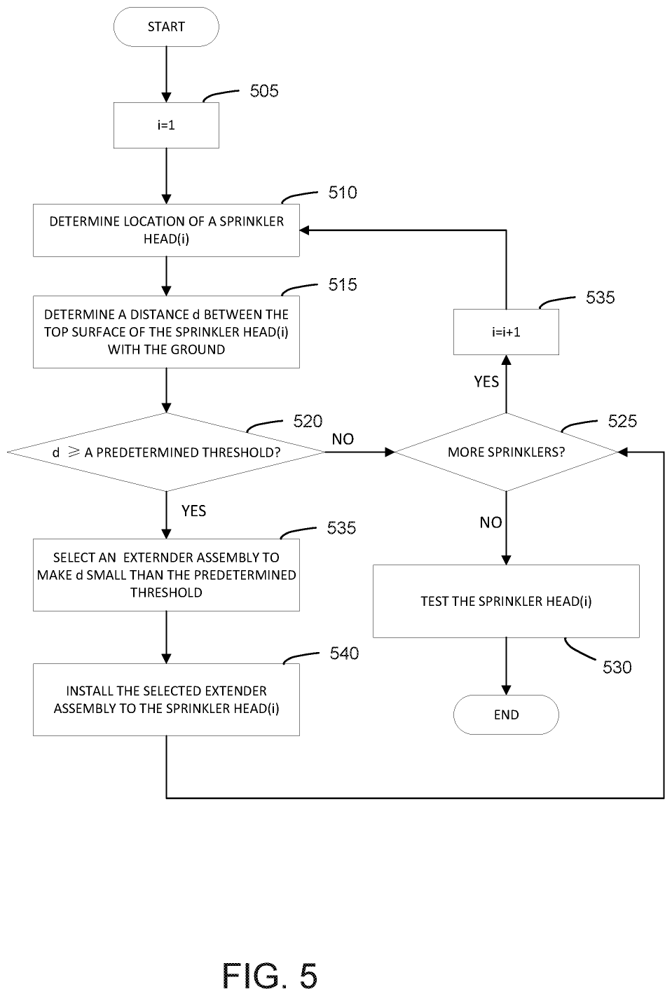

FIG. 5 depicts a flow chart of an exemplary method to identify sprinkler heads to be extended. Steps 505, 510, 515, 520, 525, 530, 535, and 540 are detailed as follows. When a sprinkler head (e.g., the sprinkler head 100A) is located, a distance d between the sprinkler head (e.g., the sprinkler head 100A) and the ground is detected. When the distance d is beyond a predetermined threshold (e.g., 2 inches), a user may identify the distance is too big, a corresponding head extension device is selected to fix the sprinkler head (e.g., the sprinkler head 100A) and make the distance is below the predetermined threshold. For example, each shaft extender is 0.5 inch, a user may select four shaft extenders and a matched cap extender to install. If the distance d is below the predetermined threshold, the user may decide there is no need to fix the sprinkler head. After the installation is finished, the user tests the sprinkler head and the method ends. In some embodiments, the cap extender has only one size. The selected shaft extenders may protrude from the cap extender and connect with the nozzle. In some embodiments, cap extenders with a variety of sizes may be manufactured. After the sprinkler head (100A) is repaired, the sprinkler head employed with the head extension device is tested to evaluate its functionality.

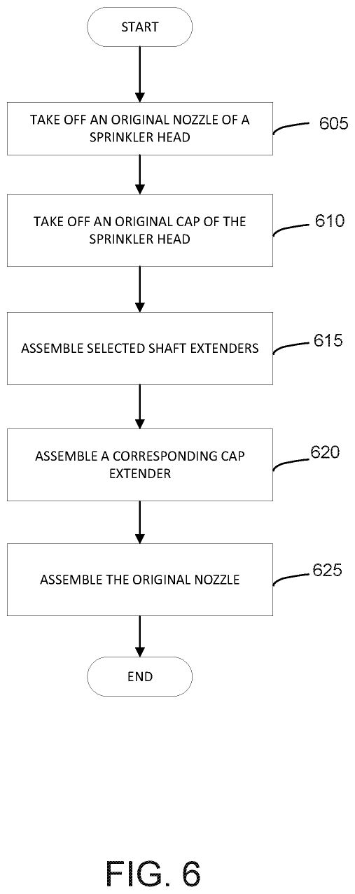

FIG. 6 depicts a flow chart of a method to assemble an exemplary sprinkler head extension to a sprinkler head. In step 605, an original nozzle (e.g., the nozzle 115) is taken off from a sprinkler head (e.g., the sprinkler head 100A). In step 610, an original cap (e.g., the cap 250) is taken off from a spray head (e.g., the spray head 210) of the sprinkler head. In step 615, a shaft extender (e.g., the shaft extender 310) is assembled to an old shaft (e.g., the shaft 220). In step 620, a cap extender (e.g., the cap extender 320) is assembled to the spray head (e.g., the spray head 210). In step 625, the original nozzle (e.g., the nozzle 115) is assembled to the shaft extender (e.g., the shaft extender 310). In some embodiments, a new nozzle may be assembled to the shaft extender to replace the original nozzle. Like reference symbols in the various drawings indicate like elements.

Although various embodiments have been described with reference to the figures, other embodiments are possible. For example, the shaft extender may be manufactured into different sizes by using different molds. For example, the shaft extender may have a length that is 1 inch, 2 inches, 3 inches, 4 inches, or 5 inches. By simply taking off the original cap and adding the shaft extender with desired length and replacing the cap into a corresponding cap extender that matches with the shaft extender, a desired height of the sprinkler head may be obtained without replacing the whole sprinkler header. In some embodiments, the sprinkler head may work with different brands of pop up heads with a change of cap threads (e.g., the thread 255).

A number of implementations have been described. Nevertheless, it will be understood that various modification may be made. For example, advantageous results may be achieved if the steps of the disclosed techniques were performed in a different sequence, or if components of the disclosed systems were combined in a different manner, or if the components were supplemented with other components. Accordingly, other implementations are within the scope of the following claims.

What is claimed is:

1. A sprinkler head extension apparatus comprising:
a hollow spray head body (210) extending along a longitudinal axis, and having a lower body longitudinal end and an upper body longitudinal end;
a hollow shaft (220) extending along the longitudinal axis and disposed within the spray head body (210), such that the spray head body (210) and the hollow shaft (220) are coaxially aligned with one another, wherein the hollow shaft (220) has a lower shaft longitudinal end and an upper shaft longitudinal end, the hollow shaft (220) is configured to facilitate a flow of fluid through the hollow shaft (220) from the lower shaft longitudinal end to the upper shaft longitudinal end;
a biasing member (240) operably coupled to the shaft and configured to bias the hollow shaft (220) in a longitudinal direction relative to the spray head body (210);
a hollow shaft extender (310) extending along the longitudinal axis and mechanically and releasably coupled to the hollow shaft (220), such that the spray head body (210), the hollow shaft (220), and the shaft extender (310) are coaxially aligned with one another, wherein the shaft extender (310) has a lower extender longitudinal end and a upper extender longitudinal end, wherein the shaft extender (310) couples at the lower extender longitudinal end to the upper shaft longitudinal end of the hollow shaft (220), wherein the shaft extender (310) is configured to facilitate the flow of fluid through the shaft extender (310) from the lower extender longitudinal end to the upper extender longitudinal end;
a hollow cap extender (320) extending along the longitudinal axis and mechanically and releasably coupled to the body upper longitudinal end, such that the spray head body (210), the hollow shaft (220), the shaft extender (310), and the cap extender (320) are coaxially aligned with one another, wherein the shaft extender (310) is disposed within disposed within the cap extender (320), wherein the cap extender (320) comprises a hollow bridge section (325b) disposed between an lower cap longitudinal end and an upper cap longitudinal end, wherein a bridge radius of the bridge section is less than both: (I) a lower cap longitudinal end radius of the lower cap longitudinal end, and (II) an upper cap longitudinal end radius of the upper cap longitudinal end; and,
a top nozzle (115) mechanically coupled to the upper extender longitudinal end, wherein when pressurized fluid is applied at the lower shaft longitudinal end, a fluid flow path is defined: (A) from the lower shaft longitudinal end, (B) through the hollow shaft (220), (C) to the upper shaft longitudinal end, (D) to the lower extender longitudinal end, (E) through the shaft extender (310), (F) to the upper extender longitudinal end, (G) through the top nozzle (115), and (H) out of the top nozzle (115).

2. The sprinkler head extension apparatus of claim 1, wherein the upper shaft longitudinal end comprises upper shaft threads (225a) that couple at the lower extender longitudinal end, to mechanically and releasably couple the shaft extender (310) to the hollow shaft (220).

3. The sprinkler head extension apparatus of claim 2, wherein the lower extender longitudinal end comprises lower extender threads (315b) that couple to the upper shaft threads (225a), to mechanically and releasably couple the shaft extender (310) to the hollow shaft (220).

4. The sprinkler head extension apparatus of claim 3, wherein the upper extender longitudinal end comprises upper extender threads (315a) that couple to the top nozzle (115), to mechanically couple the top nozzle (115) to the upper extender longitudinal end.

5. The sprinkler head extension apparatus of claim 1, wherein the upper body longitudinal end comprises upper body threads (215a) that couple to the cap extender (320), to mechanically and releasably couple the cap extender (320) to the spray head body (210).

6. The sprinkler head extension apparatus of claim 5, wherein the lower extender longitudinal end comprises lower cap threads 325c that couple to the upper body threads (215a), to mechanically and releasably couple the cap extender (320) to the hollow shaft (220).

7. The sprinkler head extension apparatus of claim 1, wherein the biasing member (240) comprises a coiled spring coiled around the hollow shaft (220).

8. The sprinkler head extension apparatus of claim 1, wherein the cap extender (320) comprises an aperture (325d) in which the top nozzle (115) is disposed.

9. The sprinkler head extension apparatus of claim 1, further comprising a seal member (245) that receives the hollow shaft (220) at the upper shaft longitudinal end, and is configured to seal the sprinkler head extension apparatus to isolate the flow of fluid through the hollow shaft (220).

10. A sprinkler head extension apparatus comprising:
a hollow spray head body (210) extending along a longitudinal axis, and having a lower body longitudinal end and an upper body longitudinal end;
a hollow shaft (220) extending along the longitudinal axis and disposed within the spray head body (210), such that the spray head body (210) and the hollow shaft (220) are coaxially aligned with one another, wherein the hollow shaft (220) has a lower shaft longitudinal end and an upper shaft longitudinal end, the hollow shaft (220) is configured to facilitate a flow of fluid through the hollow shaft (220) from the lower shaft longitudinal end to the upper shaft longitudinal end;
a biasing member (240) operably coupled to the shaft and configured to bias the hollow shaft (220) in a longitudinal direction relative to the spray head body (210);
a hollow shaft extender (310) extending along the longitudinal axis and mechanically and releasably coupled to the hollow shaft (220), such that the spray head body (210), the hollow shaft (220), and the shaft extender (310) are coaxially aligned with one another, wherein the shaft extender (310) has a lower extender longitudinal end and a upper extender longitudinal end, wherein the shaft extender (310) couples at the lower extender longitudinal end to the upper shaft longitudinal end of the hollow shaft (220), wherein the shaft extender (310) is configured to facilitate the flow of fluid through the shaft extender (310) from the lower extender longitudinal end to the upper extender longitudinal end;
a hollow cap extender (320) extending along the longitudinal axis and mechanically and releasably coupled to the body upper longitudinal end, such that the spray head body (210), the hollow shaft (220), the shaft extender (310), and the cap extender (320) are coaxially aligned with one another, wherein the shaft extender (310) is disposed within disposed within the cap extender (320); and,
a top nozzle (115) mechanically coupled to the upper extender longitudinal end, wherein when pressurized fluid is applied at the lower shaft longitudinal end, a fluid flow path is defined: (A) from the lower shaft longitudinal end, (B) through the hollow shaft (220), (C) to the upper shaft longitudinal end, (D) to the lower extender longitudinal end, (E) through the shaft extender (310), (F) to the upper extender longitudinal end, (G) through the top nozzle (115), and (H) out of the top nozzle (115).

11. The sprinkler head extension apparatus of claim 10, wherein the upper shaft longitudinal end comprises upper shaft threads (225a) that couple at the lower extender longitudinal end, to mechanically and releasably couple the shaft extender (310) to the hollow shaft (220).

12. The sprinkler head extension apparatus of claim 11, wherein the lower extender longitudinal end comprises lower extender threads (315b) that couple to the upper shaft threads (225a), to mechanically and releasably couple the shaft extender (310) to the hollow shaft (220).

13. The sprinkler head extension apparatus of claim 12, wherein the upper extender longitudinal end comprises upper extender threads (315a) that couple to the top nozzle (115), to mechanically couple the top nozzle (115) to the upper extender longitudinal end.

14. The sprinkler head extension apparatus of claim 10, wherein the upper body longitudinal end comprises upper body threads (215a) that couple to the cap extender (320), to mechanically and releasably couple the cap extender (320) to the spray head body (210).

15. The sprinkler head extension apparatus of claim 14, wherein the lower extender longitudinal end comprises lower cap threads 325c that couple to the upper body threads (215a), to mechanically and releasably couple the cap extender (320) to the hollow shaft (220).

16. The sprinkler head extension apparatus of claim 10, wherein the biasing member (240) comprises a coiled spring coiled around the hollow shaft (220).

17. The sprinkler head extension apparatus of claim 10, wherein the cap extender (320) comprises an aperture (325d) in which the top nozzle (115) is disposed.

18. The sprinkler head extension apparatus of claim 10, further comprising a seal member (245) that receives the hollow shaft (220) at the upper shaft longitudinal end, and is configured to seal the sprinkler head extension apparatus to isolate the flow of fluid through the hollow shaft (220).

19. A sprinkler head extension apparatus comprising:
a hollow spray head body (210) extending along a longitudinal axis, and having a lower body longitudinal end and an upper body longitudinal end;
a hollow shaft (220) extending along the longitudinal axis and disposed within the spray head body (210), such that the spray head body (210) and the hollow shaft (220) are coaxially aligned with one another, wherein the hollow shaft (220) has a lower shaft longitudinal end and an upper shaft longitudinal end, the hollow shaft (220) is configured to facilitate a flow of fluid through the hollow shaft (220) from the lower shaft longitudinal end to the upper shaft longitudinal end;
a biasing member (240) operably coupled to the shaft and configured to bias the hollow shaft (220) in a longitudinal direction relative to the spray head body (210);
a hollow shaft extender (310) extending along the longitudinal axis and mechanically and releasably coupled to the hollow shaft (220), such that the spray head body (210), the hollow shaft (220), and the shaft extender (310) are coaxially aligned with one another, wherein the shaft extender (310) has a lower extender longitudinal end and a upper extender longitudinal end, wherein the shaft extender (310) couples at the lower extender longitudinal end to the upper shaft longitudinal end of the hollow shaft (220), wherein the shaft extender (310) is configured to facilitate the flow of fluid through the shaft extender (310) from the lower extender longitudinal end to the upper extender longitudinal end;
a hollow cap extender (320) extending along the longitudinal axis and mechanically and releasably coupled to the body upper longitudinal end, such that the spray head body (210), the hollow shaft (220), the shaft extender (310), and the cap extender (320) are coaxially aligned with one another, wherein the shaft extender (310) is disposed within disposed within the cap extender (320); and,
a top nozzle (115) mechanically coupled to the upper extender longitudinal end, wherein when pressurized fluid is applied at the lower shaft longitudinal end, a fluid flow path is defined: (A) from the lower shaft longitudinal end, (B) through the hollow shaft (220), (C) to the upper shaft longitudinal end, (D) to the lower extender longitudinal end, (E) through the shaft extender (310), (F) to the upper extender longitudinal end, (G) through the top nozzle (115), and (H) out of the top nozzle (115),
wherein:
the upper shaft longitudinal end comprises upper shaft threads (225a) that couple at the lower extender longitudinal end, to mechanically and releasably couple the shaft extender (310) to the hollow shaft (220);
the lower extender longitudinal end comprises lower extender threads (315b) that couple to the upper shaft threads (225a), to mechanically and releasably couple the shaft extender (310) to the hollow shaft (220);
the upper extender longitudinal end comprises upper extender threads (315a) that couple to the top nozzle (115), to mechanically couple the top nozzle (115) to the upper extender longitudinal end;
the upper body longitudinal end comprises upper body threads (215a) that couple to the cap extender (320), to mechanically and releasably couple the cap extender (320) to the spray head body (210);
the lower extender longitudinal end comprises lower cap threads 325c that couple to the upper body threads (215a), to mechanically and releasably couple the cap extender (320) to the hollow shaft (220);
the cap extender (320) comprises an aperture (325d) in which the top nozzle (115) is disposed; and,

20. The sprinkler head extension apparatus of claim 1, wherein the cap extender (320) comprises a hollow bridge section (325b) disposed between an lower cap longitudinal end and an upper cap longitudinal end, wherein a bridge radius of the bridge section is less than both: (I) a lower cap longitudinal end radius of the lower cap longitudinal end, and (II) an upper cap longitudinal end radius of the upper cap longitudinal end.
